(19) United States
(12) Patent Application Publication
(10) Pub. No.: US 2021/0168112 A1
(43) Pub. Date: Jun. 3, 2021

(54) Method For Sending Electronic Messages

(71) Applicants: Karin LANG, Stubenberg (DE); Thomas WIMMER, Pocking (DE)

(72) Inventors: Karin LANG, Stubenberg (DE); Thomas WIMMER, Pocking (DE)

(21) Appl. No.: 17/091,848

(22) Filed: Nov. 6, 2020

(30) Foreign Application Priority Data
Nov. 28, 2019 (DE) 10 2019 132 296.0
Oct. 8, 2020 (DE) 10 2020 126 377.5

(51) Int. Cl. H04L 12/58

(52) U.S. Cl. CPC H04L 51/36; H04L 51/08

(57) ABSTRACT

The present invention describes a method for sending electronic messages which comprises the steps of starting up a recording system for recording a voice message, recording the voice message by means of the recording system and sending the voice message by means of at least one remote communication means and is characterized in that a recording of the voice message is recorded by means of at least one recording button which can be controlled in a user interface of the recording system, the recording system being different from an instant messenger system.

The present invention concerns a method for sending electronic messages and a device for sending electronic messages according to the generic terms of claims 1 and 8.

The inventors recognized the problem that sending a voice message, especially in common file formats such as dcc, is cumbersome. In the past, a dictation machine had to be inserted into a docking station provided for this purpose, the voice file then had to be inserted into the mail message to be sent, for example using the Windows system “Outlook”, and only then could the new mail be sent together with the voice file as a file attachment.

The task of the present invention is therefore to eliminate the above-mentioned problem and therefore to offer a method for sending electronic messages which makes it possible to send voice messages in digital form in a particularly simple manner.

The procedure for sending electronic messages according to the invention comprises in a first step the commissioning of a recording system for recording a voice message.

In a further step, the voice message is recorded by means of the recording system. In a subsequent step, the voice message is sent by at least one means of remote communication.

According to the invention, the recording of the voice message is recorded by means of at least one recording button which can be controlled in a control interface of the recording system, whereby the recording system is different from an instant messenger system.

The record button therefore serves as an integrated and/or integrable graphical user interface element, which for example appears in a toolbar of the mail sending program. This means that there is no need for time-consuming conversion and/or moving of the voice message from one data carrier (for example, from a dictation machine) to another data carrier (computer hard disk, SSD, etc.). This leads to a highly simplified procedure for sending voice messages via a remote communication medium. A means of remote communication can be a WLAN router or a mobile phone network.

According to at least one version of the procedure, it comprises a first step, after which a recording system is put into operation to record a voice message. In a second step, a voice message is recorded by means of the recording system. In a further step, the voice message is sent by means of at least one means of remote communication. In a further step, the one recording of the voice message is recorded by means of at least one recording button that can be activated in a control interface of the recording system, whereby the recording system is different from an instant messenger system.

According to at least one design, the recording system is part of an e-mail sending program, or forms an e-mail sending program itself. The e-mail sending program can be a part of the mail system “Outlook”. For this purpose, a code of the sending program can be changed so that the button for recording the voice message is displayed in a window of the user interface. The voice message itself can be stored on a hard disk, SSD or other storage device.

According to at least one other version, a user interface of the e-mail sending program displays the record button in a designated position.

According to at least one of the variants, the voice message is sent together with a text message, preferably by pressing a send button.

According to at least one other version, the recording system automatically and therefore without pressing a record button recognizes a start and/or an end of the recording process of the voice message. For this purpose, a microphone of the recording system can be connected to a speech recognition system.

According to at least one execution form, after a termination of the recording recognized by the recording system, the voice message is sent by the recording system.

According to at least one execution form, the voice message is created as an e-mail attachment by the recording system.

A further task of the present invention is in particular also that by means of the creation of the e-mail attachment, which includes the voice message, an efficiency of the entire device for sending electronic messages and in particular also a time saving in the procedure for sending electronic messages is generated.

In at least one version, the creation of the voice message and the subsequent sending of the voice message with the e-mail attachment can not only be done by manually entering the e-mail address in an input field (manual input of the e-mail address), but the sending of the voice message can also be semi or fully automatic. This can mean that the voice message is created first and then, by means of another voice command and/or at least one more gesture command, the voice message is created as an e-mail attachment and sent as an instant message, i.e. without any extra e-mail address input by the user.

In other words, for example, a voice message can be sent to a user named, for example, “User 1” by the user creating the voice message, creating it as a file fully automatically as an e-mail attachment, and sending it from the e-mail system in another command, for example, in the form “Send voice message to user 1”.

This saves in a particularly advantageous way a separate entry of the target e-mail address, so that the procedure proposed here also meets security standards, for example within a framework of semi- or fully automatic driving of a vehicle.

For example, the procedure described here is used in an electronic processing system of a vehicle or a smart device, such as a tablet, a cell phone or a portable or fixed personal computer.

The semi-automatic or fully automatic sending of voice messages as e-mail attachments described here not only reduces processing time, but also avoids the creation of extra input fields. However, the generation of extra input fields in which the e-mail address can be entered requires not only memory but also energy. This is generated particularly efficiently by shortening the generation and sending of the voice message as an e-mail attachment.

If the voice message is sent as an e-mail attachment as part of a gesture control, it is conceivable that the device described here or a sensor device connected to the device will recognize the gesture by means of a corresponding sensor system. This could be a gesture recognition in the form of a finger, arm or foot movement. Also a head movement can be stored in such a way that a certain head movement is associated with a certain email address and after completion of the head movement automatically the gesture recognition the device described here sends the voice message to the correspondingly assigned email address.

The same can also be done by means of appropriate voice commands. At least one voice command is therefore at least linked to the sending to an e-mail address. For example, a gesture and/or a voice command can be uniquely, preferably unambiguously, assigned to an e-mail address.

In addition, in at least one execution form, the generation of the voice message may be a process compatible with a graphical user interface, namely a graphical user interface and/or operating system named “Windows” and/or “IOS” and/or “Linux”. This may mean that the procedure described here is integrated as an app or as a supplementary program or software update in the above-mentioned user systems and is part of them. For example, the procedure described above may be fully compatible with the e-mail program Outlook or may be a part of Outlook, so that by means of such an operating system-related and compatible e-mail program, for example the e-mail program “Outlook”, the voice message can be sent as an e-mail attachment partially or fully automatically via the above-mentioned language and/or gesture control.

In other words, the e-mail is created as an attachment using the procedure described here and this is automatically dragged or uploaded into an e-mail sending element, i.e. an e-mail sending window of for example Outlook, and then sent by this operating system, i.e. for example Outlook.

To this end, it is conceivable that in a vehicle operating system of a car or truck or other vehicle the corresponding operating system, for example Windows, 10S, Linux (with exemplary further use of compatibility programs, such as Apple carplay, Windows carplay, etc.), the message is sent by an application system of the vehicle itself (which for example has a SIM card) via the mobile transmission system, preferably via LTE+ or 5G.

All this saves not only computer capacity, but also processing time, which in turn has an impact on the energy requirements of the entire device and the entire process, i.e. it considerably reduces the energy requirement, which is one of the tasks of the present application. In this respect, the procedure described here can be different from such a procedure or program, which is a self-contained dispatch program.

In other words, the inventors came up with the idea that in at least one version the procedure described here can be fully integrated into already existing procedures for sending messages of the above-mentioned user operating systems.

Also a voice recognition can be used, in particular the invention device described here, to supplement the voice message and/or the gesture control with voice recognition. Every user can program the gesture control himself and can even be recognized automatically by the system. Once the system has recognized the user's voice, the system knows which commands the user has programmed for the gesture control. These commands can also be changed or deleted by the user at any time.

Furthermore, the present invention comprises a device for sending electronic messages, the device comprising at least one recording system for recording a voice message and at least one remote communication means for sending the voice message via at least one remote communication means.

According to at least one embodiment, the recording system is set up and provided so that a recording of the voice message can be recorded by means of at least one recording button which can be controlled in a control interface of the recording system, wherein the recording system is different from an instant messenger system.

In the following, the invention described here is described in more detail by means of an example of execution and the corresponding figure. Components with the same or similar effects are provided with the same reference signs.

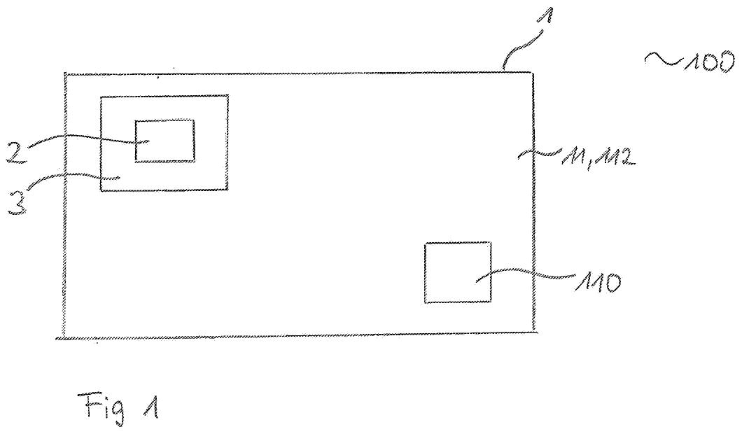

FIG. 1 shows a design example of a process and a device 100 in accordance with the invention for operating a process for sending electronic messages.

As can be seen in FIG. 1, a procedure for sending electronic messages is shown there as an example, which comprises in a first step the commissioning of a recording system 1 for recording a voice message 2, in a further step the voice message 2 is recorded by means of the recording system 1 and in a third step the voice message 2 is sent by means of at least one remote communication medium. The recording of the voice message 2 takes place by means of at least one recording button 110 which can be controlled in a control interface 11 of the recording system 1, whereby the recording system 1 is different from an instant messenger system.

Furthermore, FIG. 1 shows that the Recording System 1 Tel is an e-mail sending program or forms an e-mail sending program itself, whereby a user interface 112 of the e-mail sending program displays the Record button 110 in a designated position.

As further shown in FIG. 1, voice message 2 is sent together with a text message 3, preferably by pressing a send button, whereby recording system 1 automatically and therefore without pressing a record button 110 recognizes a start and/or an end of the recording process of voice message 2 and after a termination of the recording of voice message 2 recognized by recording system 1, voice message 2 is sent by recording system 1, whereby voice message 2 is created as an e-mail attachment by recording system 1.

Furthermore, FIG. 1 shows a device 100 for sending electronic messages, which comprises at least one recording system 1 for recording a voice message 2 and at least one remote communication means 3 for sending the voice message 2 by means of at least one remote communication means 3. It can be seen that the device 100 for sending electronic messages is characterized in that the recording system 1 is set up and provided for the purpose of recording a voice message 2 by means of at least one recording button 110 which can be controlled in a control interface 11 of the recording system 1, the recording system 1 being different from an instant messenger system.

The invention is not limited by the description based on the execution example. Rather, the invention comprises any new feature as well as any combination of features, which in particular includes any combination of features in the claims, even if this feature or combination itself is not explicitly stated in the claims or in the design example.

### Key to Figure

1 acquisition system
2 voice message
3 text message
11 control interface
100 device
110 recording button
112 user interface

1. Method for sending electronic messages comprising the steps of
Commissioning of a recording system (1) for recording a voice message (2),
Recording the voice message (2) using the recording system (1),
Sending the voice message (2) by means of at least one means of remote communication,
characterized by
a recording of the voice message (2) is recorded by means of at least one recording button (110) which can be controlled in an control surface (11) of the recording system (1), wherein the recording system (1) is different from an instant messenger system.

2. The procedure according to claim 1,
characterized by
the recording system (1) is part of an e-mail sending program or forms an e-mail sending program itself.

3. The procedure according to claim 1,
characterized by
a user interface (112) of the e-mail sending program displays the record button (110) in a designated position.

4. The procedure according to claim 1,
characterized by
the voice message (2) is sent together with a text message (3), preferably by pressing a send button.

5. The procedure according to claim 1,
characterized by
the recording system (1) automatically and therefore without pressing a recording button (110) recognizes a start and/or an end of the recording process of the voice message (2).

6. The procedure according to claim 1,
characterized by
after a termination of the recording of the voice message (2) recognized by the recording system (1), the voice message (2) is sent by the recording system (1).

7. The procedure according to claim 1,
characterized by
the voice message (2) is created as an e-mail attachment by the recording system (1)

8. A device (100) for sending electronic messages, comprising
at least one recording system (1) for recording a voice message (2),
at least one remote communication means (3) for sending the voice message (2) by means of at least one remote communication means (3),
characterized by
the recording system (1) is set up and provided so that a recording of the voice message (2) can be recorded by means of at least one recording button (110) which can be activated in a control interface (11) of the recording system (1), wherein the recording system (1) is different from an instant messenger system.
